(19) United States
(12) Patent Application Publication
(10) Pub. No.: US 2013/0205455 A1
(43) Pub. Date: Aug. 8, 2013

(54) SYSTEM AND METHOD OF PERFORMING ATOMIC FORCE MEASUREMENTS

(71) Applicant: University of Western Australia, PERTH Western Australia (AU)

(72) Inventors: John Marcel Dell, BULL CREEK (AU); Mariusz Martyniuk, WATTLE GROVE (AU); Adrian John Keating, MT HAWTHORN (AU); Gino Michael Putrino, DIANELLA (AU); Lorenzo Faraone, MT LAWLEY (AU); Dilusha Silva, BALLAJURA (AU)

(73) Assignee: UNIVERSITY OF WESTERN AUSTRALIA, PERTH Western Australia (AU)

(21) Appl. No.: 13/761,987

(22) Filed: Feb. 7, 2013

(30) Foreign Application Priority Data
Feb. 7, 2012 (AU) 2012900444

(51) Int. Cl. G01Q 60/24

(52) U.S. Cl. CPC G01Q 60/24
USPC 850/33

(57) ABSTRACT

A system for performing atomic force measurements including: a sensor including: a beam having a first side and a second side, the beam including a tip positioned on a surface of the first side for interacting with a sample; and a grating structure positioned adjacent the second side of the beam, the grating structure including an interrogating grating coupler configured to direct light towards the beam; a light source optically coupled to an input of the sensor for inputting light; and an analyser coupled to an output of the sensor; wherein the beam and the interrogating grating coupler form a resonant cavity, a movement of the beam modulates the light source and the analyser determines a deflection of the beam according to the modulated light.

### CROSS REFERENCE TO RELATED APPLICATION

This application claims priority to Australian Patent Application No. 2012900444, filed Feb. 7, 2012, the disclosure of which is hereby incorporated by reference in its entirety.

1. Technical Field

This invention relates generally to a system and method of performing atomic force measurements and in particular to a system and method of performing atomic force measurements using beams and/or cantilevers.

2. Background Art

As is known in the art, an Atomic Force Microscope (AFM) consists of a cantilever with a pointed tip or probe at its end that is used to scan a sample surface. The cantilever is typically made of silicon or silicon nitride with a tip radius of curvature in the order of nanometers using micro-electromechanical fabrication techniques. When the tip is brought into proximity of the sample surface, forces between the tip and the sample lead to a deflection of the cantilever according to Hooke's law.

### SUMMARY OF INVENTION

Interatomic forces between the probe tip and the sample surface cause the cantilever to deflect as the sample's surface topography (or other properties) change as the tip is scanned across the sample. A laser light reflected from the back of the cantilever measures the deflection of the cantilever. This information is fed back to a computer, which generates a map of topography and/or other properties of interest.

Various measurements can be made including measuring either the deflection of the cantilever (static mode) or a vibration frequency of the cantilever (dynamic mode). In some applications, the tip is coated with a thin film of ferromagnetic material that reacts to magnetic areas on the sample surface. Some applications include:

Measuring 3-dimensional topography of an integrated circuit device

Roughness measurements for chemical mechanical polishing

Analysis of microscopic phase distribution in polymers

Mechanical and physical property measurements for thin films

Imaging magnetic domains on digital storage media

Imaging of submicron phases in metals

Defect imaging in IC failure analysis

Microscopic imaging of fragile biological samples

Metrology for compact disk stampers

A problem with current AFMs is that the sensitivity is limited by shot noise in the optical detection system. Although Brownian motion of the cantilever is a contributor to the noise, in practice it is not a factor as the shot noise is substantially greater than the noise induced by Brownian motion. While noise induced by Brownian motion may be reduced by cooling the cantilever, this is not practical for current AFMs as it may interfere with the alignment of the optical system. A further problem is that, the process of measuring an entire surface of a sample is time consuming, as the probe tip must make many passes over the sample in order to build up an image.

Yet a further problem with current AFMs is that the probe often needs to be replaced, and each time the probe is replaced the optical detection system needs to be re-calibrated, which is a time consuming process.

There is therefore a need for an improved system and method of performing atomic force measurements.

### OBJECT OF THE INVENTION

It is an object of some embodiments of the present invention to provide consumers with improvements and advantages over the above described prior art, and/or overcome, and alleviate one or more of the above described disadvantages of the prior art, and/or provide a useful commercial choice.

### SUMMARY OF THE INVENTION

In one form, although not necessarily the only or broadest form, the invention resides in a system for performing atomic force measurements including:

a sensor including:
a beam having a first side and a second side, the beam including a tip positioned on a surface of the first side for interacting with a sample; and
a grating structure positioned adjacent the second side of the beam, the grating structure including an interrogating grating coupler configured to direct light towards the beam;

a light source optically coupled to an input of the sensor for inputting light; and

an analyser coupled to an output of the sensor; wherein

the beam and the interrogating grating coupler form a resonant cavity, a movement of the beam modulates the light source and the analyser determines a deflection of the beam according to the modulated light.

Preferably, the beam is a cantilever beam. Alternatively, the beam is fixed at opposite ends and includes a flexible portion between the ends. Preferably, the tip is positioned between the two ends of the beam.

Preferably, the modulated light is amplitude modulated. Alternatively or additionally, the modulated light is frequency modulated.

Preferably, the system includes a plurality of sensors.

Preferably, the system further includes a de-multiplexer wherein an input of the de-multiplexer is optically connected to the light source and each output of a plurality of outputs of the de-multiplexer is optically connected to a respective input of a grating structure of a respective sensor.

Preferably, the system further includes a multiplexer wherein each output of the plurality of grating structures of a respective sensor is optically connected to an input of the multiplexer, and the output of the multiplexer is connected to the analyser.

Preferably the de-multiplexer is a wavelength division de-multiplexer.

Preferably, light input into the multiplexer is separated into a plurality of discrete wavelengths and/or wavelength bands.

Preferably, each wavelength of the plurality of discrete wavelengths is modulated by a respective sensor.

In another form the invention resides in a method of performing atomic force measurements on a sample, the method including the steps of:

inputting light into a resonant cavity formed between a beam and a grating structure of a sensor;

receiving at an analyser light modulated by a movement of the beam; and

analysing the modulated light to determine a characteristic of the sample.

Preferably, the characteristic is a topography of the sample.

### BRIEF DESCRIPTION OF THE DRAWINGS

To assist in understanding the invention and to enable a person skilled in the art to put the invention into practical effect, an embodiment of the invention is described with reference to the accompanying drawings in which:

FIG. 1 is a bottom perspective view of a system for performing atomic force measurements;

FIG. 2 is a cross-sectional end view of a sensor of FIG. 1;

FIG. 3 is a block diagram illustrating a system of an array of the sensors shown in FIGS. 1 and 2 for performing atomic force measurements; and

FIG. 4 illustrates a method of performing atomic force measurements on an object, according to an embodiment of the present invention.

### DETAILED DESCRIPTION OF THE PREFERRED EMBODIMENT

Elements of the invention are illustrated in concise outline form in the drawings, showing only those specific details that are necessary to understanding the embodiments of the present invention, but so as not to clutter the disclosure with excessive detail that will be obvious to those of ordinary skill in the art in light of the present description.

In this patent specification, adjectives such as first and second, left and right, front and back, top and bottom, etc., are used solely to define one element from another element without necessarily requiring a specific relative position or sequence that is described by the adjectives. Words such as “comprises” or “includes” are not used to define an exclusive set of elements or method steps. Rather, such words merely define a minimum set of elements or method steps included in a particular embodiment of the present invention. It will be appreciated that the invention may be implemented in a variety of ways, and that this description is given by way of example only.

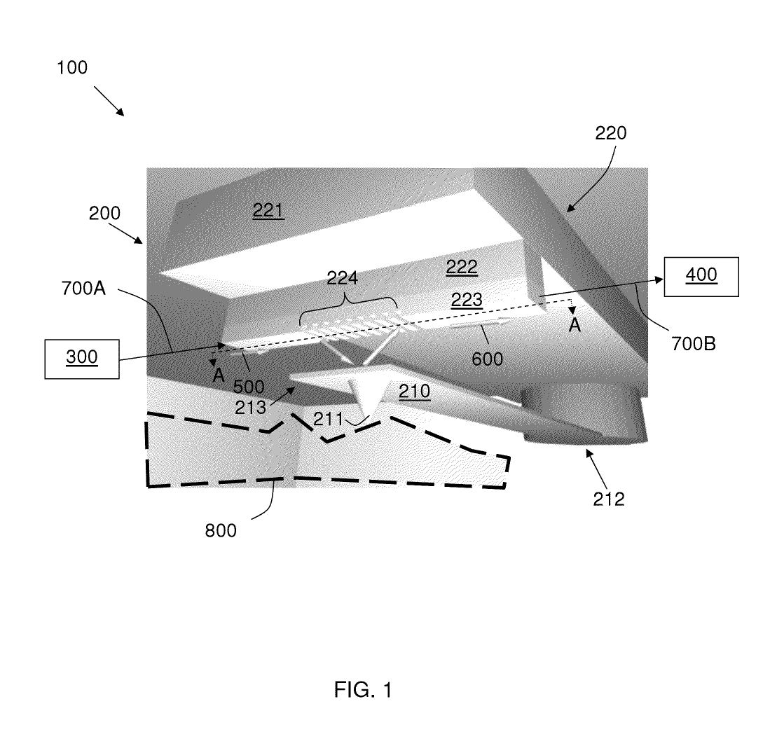

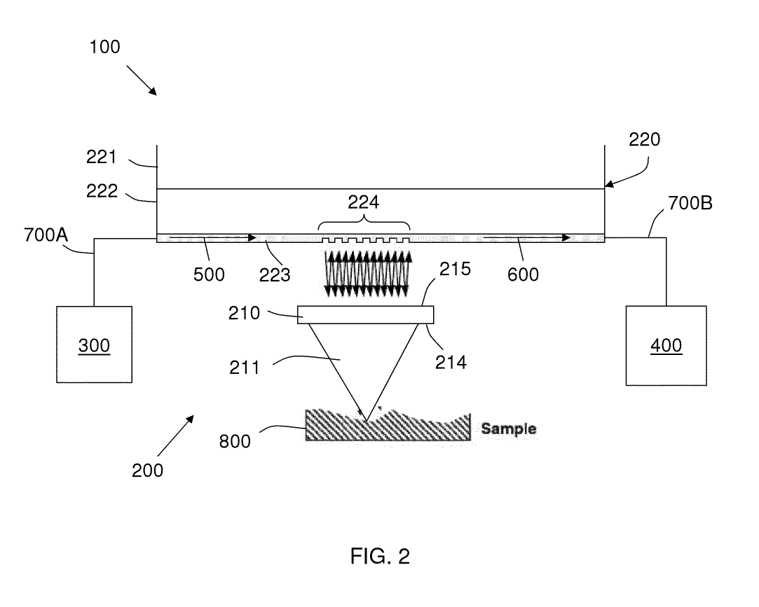

FIG. 1 is a bottom perspective view of a system 100 for measuring Atomic Force according to a first embodiment of the present invention, and FIG. 2 is a cross-sectional end view through A-A of FIG. 1. Referring to FIGS. 1 and 2, the system 100 includes a sensor 200, a light source 300 and an analyser 400. The light source 300 is connected to an input of the sensor 200 by an optical waveguide 700A such as an optical fibre. An output of the sensor 200 is connected to the analyser 400 by an optical waveguide 700B such as an optical fibre.

In one embodiment, the sensor 200 is made using micro-electro-mechanical systems (MEMS) technology and includes a beam in the form of a cantilever beam 210 and a grating structure 220 positioned adjacent the cantilever beam 210. The cantilever beam 210 is planar and includes a tip 211 which is pointed. The cantilever beam 210 includes a first side 214 and a second side 215. The tip 211 is positioned on the first side 214 of the cantilever beam 210 and towards a distal end 213 of the cantilever beam 210. The tip 211 extends away from the cantilever beam 210 towards a sample 800 to be measured. A proximal end 212 of the cantilever beam 210 is fixed allowing the distal end 213 to flex as the tip 211 is moved over the sample 800.

In another embodiment (not shown), the beam is fixed at both the distal end and the proximal end but allowing the beam to flex. A tip is positioned in between the distal end and the proximal end. Preferably the tip is positioned mid-way between the distal end and the proximal end. However it should be appreciated that the tip may be positioned anywhere between the distal end and the proximal end. By fixing the beam at both ends, Brownian motion is reduced, and sensitivity of a measurement is increased.

In one embodiment, the grating structure 220 uses Silicon on Insulator (SOI) technology and includes a substrate 221, a buried oxide layer 222 and a waveguide layer 223. Furthermore, the substrate 221 and the waveguide layer 223 are made from silicon. The buried oxide layer 222 is formed on the substrate 221 and the waveguide layer 223 is formed on the buried oxide layer 222. The waveguide layer 223 includes grooves to form an interrogating grating coupler 224 and the interrogating grating coupler 224 is positioned adjacent the second side 215 of the cantilever beam 210. In one embodiment, the waveguide layer 223 is 220 nm thick fabricated over a 2000 nm buried oxide layer 222 using an infra-red light source 300. However it should be appreciated that other thicknesses may be used, for example between 100 nm and 2000 nm.

Although the grating structure 220 has been described in relation to SOI technology, a person skilled in the art will appreciate that the grating structure 220, including the waveguide layer 223 and the buried oxide layer 222, may be made from many other materials. The main requirement is that the waveguide layer 223 has a higher refractive index than the buried oxide layer 222 so as to get the total internal reflections in the waveguide. For example, the waveguide layer 223 may also be made from, but is not limited to, Germanium (Ge) and Silicon Oxy Nitride and the buried oxide layer 222 may be made from SU-8, Silicon dioxide (SiO2) or Magnesium Oxide (MgO). In addition, the thicknesses used to fabricate the waveguide layer 223 and the buried oxide layer 222 depend on the materials used and the wavelength of the light source 300.

Typically a gap between the interrogating grating coupler 224 and the cantilever beam 210 is between 0.05 and 10 μm. However it should be appreciated that other distances may be used depending on the wavelength of the light source 300 and the types of materials used for the grating structure 220.

Although in the example above the sensor 200 has been designed using a light source 300 in the infra red band (with a wavelength of between 0.74 μm to 30 μm), it should be appreciated that the light source 300 may produce light in the visible band (with a wavelength between 390 nm to 750 nm) or the ultra-violet band (with a wavelength between 10 nm to 400 nm).

A pattern or shape of the interrogating grating coupler 224, for example dimensions of grooves of the interrogating grating coupler 224, determines a resonance of light resonating between the interrogating grating coupler 224 and the cantilever beam 210.

In use, the unmodulated light 500 is input to the sensor 200. The unmodulated light 500 propagates along the silicon waveguide layer 223 until the unmodulated light 500 exits the waveguide layer 223 towards the cantilever beam 210 at the interrogating grating coupler 224. The interrogating grating coupler 224 couples and directs light out of the waveguide 223 towards the cantilever beam 210 and couples light reflected from the second side 215 of the cantilever beam 210 back into the waveguide thereby forming a resonant cavity with the cantilever beam 210. As the cantilever beam 210 moves towards and away from the interrogating grating coupler 224, an intensity and/or frequency of light output to the analyser 400 is modulated as a function of the separation between the interrogating grating coupler 224 and the cantilever beam 210. From the modulation, the analyser 400 may determine a displacement of the cantilever beam 210 in order, for example, to determine a topography. In some embodiments the second side 215 of the cantilever beam 210, is coated with a reflective material such as gold in order to increase the reflectivity.

Although referred to as unmodulated light, it should be appreciated that the light input to the sensor 200 may be modulated with a first modulation. As the first modulated light passes through the sensor 200 it is modulated by a second modulation. The second modulation may then be analysed by the analyser 400 in order to determine a displacement of the cantilever beam 210.

It should be appreciated that in order to perform a scan, the sample 800 may be fixed and the sensor 200 moved across the sample 300 under the control of the analyser 400. Alternatively, the sample 800 may be moved under the control of the analyser and the sensor 200 may be stationary.

An electrostatic element may be used to control an initial deflection of the beam so as to tune the resonance of the optical cavity to its most sensitive position. An electrode is placed underneath the beam or cantilever beam 210, but not over the grating structure 220. The voltage between the electrode and the metal on the underside of the beam is then controlled to attract or repel the beam as necessary.

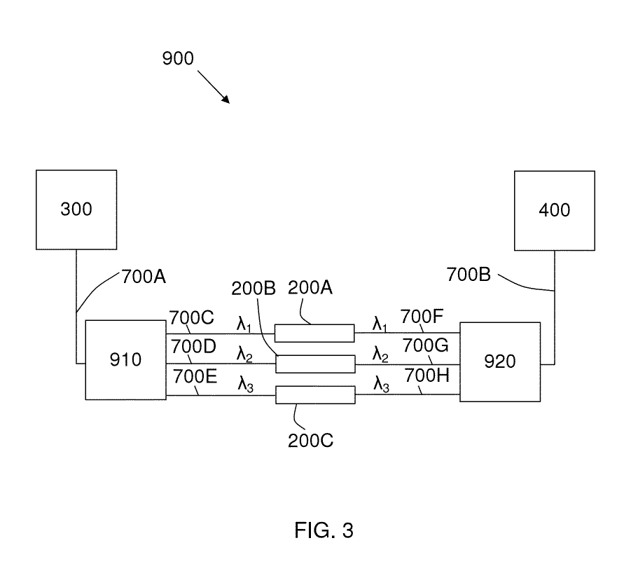

The sensor 200 of the present invention may be used in an array in order to measure larger sections of the sample 800. FIG. 3 is a block diagram illustrating a system of an array of sensors 200 shown in FIGS. 1 and 2 for performing atomic force measurements according to an embodiment of the present invention. The system 900 includes a plurality of sensors 200A, 200B, 200C formed in a row. However it should be appreciated that the sensors 200A, 200B, 200C may be positioned in any suitable arrangement.

In this embodiment, the light source 300 is connected to a wavelength division de-multiplexer 910 via a single optical waveguide 700A. The wavelength division de-multiplexer 910 separates the light source 300 into a plurality of discrete wavelengths or wavelength bands λ₁, λ₂ and λ₃. Each output of the wavelength division de-multiplexer 910 is connected to a respective sensor 200A, 200B, 200C by a respective optical waveguide 700C, 700D, 700E in order to couple the light at each wavelength λ₁, λ₂, λ₃ to a respective grating structure 220 of a respective cantilever sensor 200A, 200B, 200C. As each cantilever beam 210 of a respective sensor 220A, 220B, 220C moves it modulates the light at the respective wavelength or wavelength band λ₁, λ₂, λ₃.

The modulated light 600 at each wavelength λ₁, λ₂, λ₃ is then multiplexed by a multiplexer 920. Each sensor 200A, 200B, 200C is connected to the multiplexer 920 by a respective optical waveguide 700F, 700G, 700H such as an optical fibre. An output of the multiplexer 920 is connected to the analyser 400 by optical waveguide 700B and the modulated light at each wavelength λ₁, λ₂, λ₃ is passed to the analyser 400. The analyser 400 analyses the modulated light 600 at each discrete wavelength or wavelength band λ₁, λ₂, λ₃ to determine a movement of each sensor 200A, 200B, 200C and accordingly determine a characteristic of the sample 800.

In another embodiment, the light from the light source 300 may not be de-multiplexed into separate wavelengths; rather each sensor 200 in the array may be supplied from its own light source 300 or with a same wavelength of light from a same light source 300. Furthermore, an output from each sensor 200 may connect to a separate analyser 400, and each output analysed using a computer for example.

According to certain embodiments, the system 100 includes a movement sensor (not shown), to determine the relative motion between the sensor 200 and the sample 800. This enables the determination of a contour of a sample irrespective of the rate of movement of the sample.

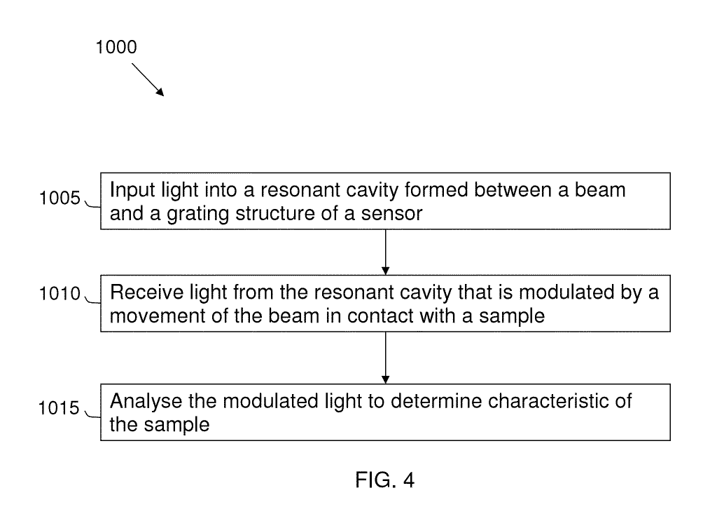

FIG. 4 illustrates a method 1000 of performing atomic force measurements on an object, according to an embodiment of the present invention.

At step 1005, light is input into a resonant cavity formed between a beam and a grating structure of the sensor. A tip of the beam is positioned adjacent to and in contact with the object, such that the beam moves according to a contour of the sample.

At step 1010, the light from the resonant cavity is received at an analyser, the light modulated according to a position of the beam.

At step 1015, the modulated light is analysed to determine a contour of the sample.

Steps 1005-1015 are advantageously performed on multiple points of the object, either sequentially, for example through movement of the beam across the object, in parallel, for example through the use of several beams and resonance cavities, or through a combination of series and parallel.

It should be appreciated that the present invention may be used in a variety of modes such as a static mode (where the beam flexes) and a dynamic mode (where the cantilever beam oscillates) in order to perform a variety of measurements.

For example the invention may be used in a contact mode where the sensor is scanned at a constant force between the sensor and a sample surface to obtain a 3D topographical map.

In an Intermittent Contact (Tapping Mode) the cantilever beam is oscillated at or near its resonant frequency. The oscillating tip is then scanned at a height where it barely touches or “taps” the sample surface. The analyser monitors the sensor position and a vibrational amplitude to obtain topographical and other property information allowing topographical information can be obtained even for fragile surfaces.

An advantage of the present invention is that the optical readout of the grating structure 220 leads to increased sensitivity over existing free space optical monitoring. The present invention uses an optical resonant cavity formed between the grating structure 220 and the cantilever beam 210, or doubly clamped beam, coupled to a waveguide to increase an amplitude of a signal output from the sensor 200 to levels significantly above the shot noise and thereby increasing the signal to noise ratio.

Another advantage is that the necessity to align the optics of an AFM whenever the probe is replaced is effectively eliminated due to the close coupling of the optical cavity to the waveguide. This is because the sensor 200 and the AFM may be fabricated such that when installed, the waveguide layer 223 aligns with the light source 300 in the AFM.

In addition Brownian motion noise may be reduced by clamping the beam at each end and a further reduction in Brownian noise may be made by cooling the sensor 200.

Finally, miniaturization of the AFM may be achieved allowing multiple beams and AFM tips to form an array and to be integrated in the one structure, effectively increasing the scan rate.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this patent specification is intended to embrace all alternatives, modifications and variations of the present invention that have been discussed herein, and other embodiments that fall within the spirit and scope of the above described invention.

What is claimed is:

1. A system for performing atomic force measurements including:
a sensor including:
a beam having a first side and a second side, the beam including a tip positioned on a surface of the first side for interacting with a sample; and
a grating structure positioned adjacent the second side of the beam, the grating structure including an interrogating grating coupler configured to direct light towards the beam;
a light source optically coupled to an input of the sensor for inputting light; and
an analyser coupled to an output of the sensor; wherein
the beam and the interrogating grating coupler form a resonant cavity, a movement of the beam modulates the light source and the analyser determines a deflection of the beam according to the modulated light.

2. The system of claim 1 wherein the beam is a cantilever beam.

3. The system of claim 1 wherein the beam is fixed at opposite ends.

4. The system of claim 3, wherein the beam includes a flexible portion between the ends

5. The system of claim 3 wherein the tip is positioned between the two ends of the beam.

6. The system of claim 1 wherein the modulated light is amplitude modulated.

7. The system of claim 1 wherein the modulated light is frequency modulated.

8. The system of claim 1 including a plurality of sensors.

9. The system of claim 8 including a de-multiplexer wherein an input of the de-multiplexer is optically connected to the light source and each output of a plurality of outputs of the de-multiplexer is optically connected to a respective input of a grating structure of a respective sensor.

10. The system of claim 8 further includes a multiplexer wherein each output of the plurality of grating structures of a respective sensor is optically connected to an input of the multiplexer, and the output of the multiplexer is connected to the analyser.

11. The system of claim 9 wherein the de-multiplexer is a wavelength division de-multiplexer.

12. The system of claim 11 wherein light input into the multiplexer is separated into a plurality of discrete wavelengths.

13. The system of claim 11 wherein light input into the multiplexer is separated into a plurality of discrete wavelength bands.

14. The system of claim 12 wherein each wavelength of the plurality of discrete wavelengths is modulated by a respective sensor.

15. A method of performing atomic force measurements on a sample, the method including the steps of:
inputting light into a resonant cavity formed between a beam and a grating structure of a sensor;
receiving at an analyser light modulated by a movement of the beam; and
analysing the modulated light to determine a characteristic of the sample.

16. The method of claim 14 wherein the characteristic is a topography of the sample.
